(19) United States
(12) Patent Application Publication
(10) Pub. No.: US 2003/0214146 A1
(43) Pub. Date: Nov. 20, 2003

(54) Movable modular window assembly

(76) Inventors: Robert R. Frutig, Bowling Green, OH (US); Charles E. Ash, Perrysburg, OH (US)

Correspondence Address: Marshall & Melhorn, LLC, Four SeaGate, 8th Floor, Toledo, OH, 43604, US

(21) Appl. No.: 10/392,155

(22) Filed: Mar. 19, 2003

Related U.S. Application Data
(60) Provisional application No. 60/367,677, filed on Mar. 26, 2002.

(51) Int. Cl. B60J 1/02

(52) U.S. Cl. 296/93

(57) ABSTRACT

A movable modular window assembly, having as a component thereof, a flexible seal, having a base portion and two arm-like projections, secured to a major surface of a transparent substrate material, is disclosed. A peripheral gasket, and the seal, spaced inwardly from the gasket, are, preferably, molded onto the transparent substrate in a single molding operation.

### BACKGROUND

The present invention is directed to a movable modular vehicle window assembly for closing an opening in a vehicle body. More specifically, the present invention relates to a flexible seal which is a component of the modular window assembly.

Installation of transparent materials, especially glass, in viewing areas of vehicles, has been accomplished in many ways as vehicle designs have evolved to include larger and larger pieces of glass having high degrees of curvature, and the desire for an aerodynamic “flush-mounted” and/or “frameless” appearance. Additionally, vehicle designers also desire windows in vehicles such as mini-vans and sport utility vehicles to perform different functions than in the past.

At the same time, vehicle manufacturers constantly are looking for ways to streamline the vehicle assembly process, and to obtain all these benefits at a reduced cost.

### SUMMARY OF THE INVENTION

The present invention achieves the above-desired objectives by combining advanced thermoplastic elastomer and advanced adhesive technology to create an aesthetically pleasing, movable vehicle window assembly having a transparent substrate with a flexible seal secured to a major surface of the substrate. Preferably, the flexible seal is secured by molding it to the major inner surface of the substrate, which comprises, for example, a sheet of glass.

The movable vehicle window provides additional airflow through the vehicle passenger compartment when it is in the open position. The seal component of the subject window assembly and the means by which such seal prevents entry of dirt, water and other undesirable elements, when the vehicle window is in the closed position, is also encompassed in the present invention.

### BRIEF DESCRIPTION OF THE DRAWINGS

FIG. 1 is a plan view of the flexible frame, and the flexible seal which have been molded onto the substrate material. FIG. 2 is a cross-sectional view of the flexible seal.

FIG. 3 is a cross-sectional view of the movable modular window assembly when the vehicle window is in the closed position.

FIG. 4 is a plan view of a suitable substrate material showing a possible application of an adhesion promoting primer on at least a portion of a major surface of the substrate.

### DETAILED DESCRIPTION OF THE PREFERRED EMBODIMENT

The invention is a modular, movable window assembly having a flexible seal suitable for closing an opening in a vehicle body. Referring to FIG. 5, a suitable substrate material 10 having leading and trailing portions 12, 14 is shown. The substrate material may be any suitable automotive glass. Preferably, the glass is a privacy glass having a visible light transmittance less than 70%. The substrate material may also be a suitable plastic material, such as a polycarbonate. Any suitable substrate material will have major inner 21 and outer 23 surfaces with a peripheral edge between the major surfaces. An adhesion promoting primer 16 preferably is disposed on a peripheral portion of at least one major surface 18 of the substrate 10, and as necessary, on some or all of the edge portion (not shown) of the substrate 10. The adhesion promoting primer may be any suitable primer, but is preferably a silane material.

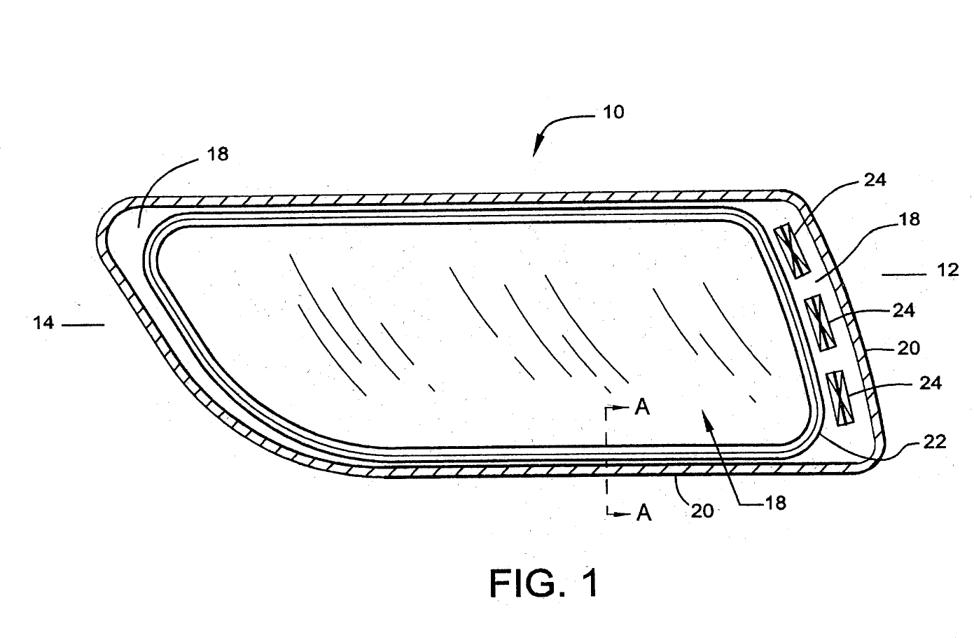

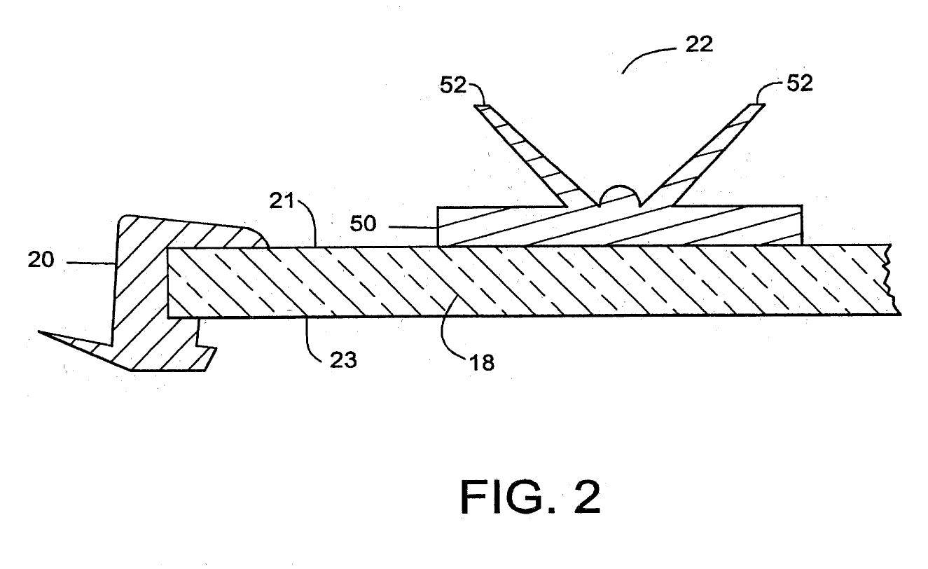

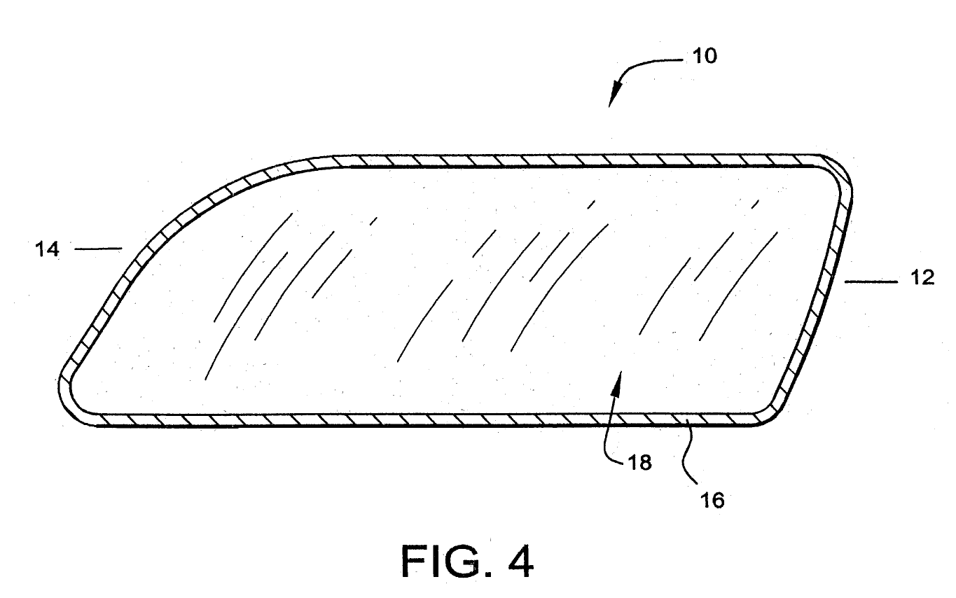

Referring now to FIG. 1, a flexible molded-on frame 20 and flexible molded-on seal 22 are adhered via a molding process to the glass substrate material. The flexible seal 22 and flexible frame 20 are adhered to at least one major surface 18 of the substrate 10 and the flexible frame may also be adhered to an edge or peripheral portion 46 as shown in FIG. 4. The portions of the substrate 10 to which the flexible frame 20 and seal 22 are adhered have preferably previously been treated with an adhesion-promoting primer. The flexible frame and seal components may be of any suitable thermoplastic elastomer material (TPE). Preferably, the flexible frame and seal components are of a polyurethane or polyester material.

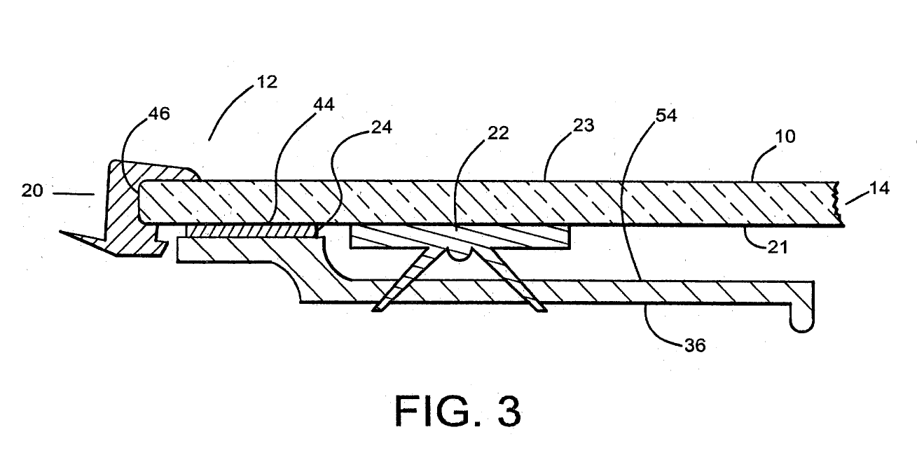

Still with reference to FIG. 1, a flexible multi-component adhesive 44 (see FIG. 3) is applied to designated areas 24 on the leading portion 12 of substrate 10. The designated areas 24 may be co-planar with the major surface 18 of the substrate 10, or may be slightly raised to better bondingly contact the bonding areas 34 in the rigid nonmetallic frame 36. The adhesive material bonding the substrate/frame/seal components to the preformed rigid frame must be flexible so as to function as a hinge component. The adhesive may be any suitable adhesive system, for example, a multi-component adhesive system. Preferably, the multi-component adhesive system is a two-component urethane adhesive system.

As shown in FIG. 2 a specialized seal 22 having a base portion 50 and two arm-like projections 52 are a feature of an especially preferred embodiment of the present invention. The seal structure 22 of FIG. 2 may be referred to as a “double-whisker” seal. The arm-like projections 52 are, typically, at an angle greater than 90°, but less than 120° in relation to each other. The base portion 50 of seal structure 22 and the arm-like projections of the seal structure 22 may be of the same or different materials.

As shown in FIG. 3, as a feature of the present invention seal structure 22 is molded onto glass substrate 10 during the same molding operation during which flexible frame 20 is molded onto glass substrate 10. Such a single molding operation, involving simultaneously molding on two substantially different structures spaced apart on a substrate was one of the problems overcome by the inventors. There are substantial benefits which have been shown to accrue from this solution.

The assembled molded on frame 20 and seal 22 and flexible adhesive 44 bonding these components to the rigid non-metallic frame 36 is shown in cross-section in FIG. 3. In this configuration, trailing portion 14 of substrate 10 is capable of pivotable movement in relation to leading portion 12, the flexible adhesive 44 acting as a hinge. Such pivotable movement is typically on the order of 5°-15° between the trailing portion 12 of substrate 10 and rigid non-metallic frame 36.

When the substrate 10 is in its closest proximity to rigid non-metallic frame 36, i.e. the window is closed, seal 22, which is molded on to substrate 10, acts to prevent moisture or dirt from entering the passenger compartment of the vehicle. It does so by arm-like projections 52 both being in sealing contact with outer surface 54 of rigid nonmetallic frame 36.

The above-described assembly is particularly suitable for use as what is known as a swing-out rear quarter window for vans, mini-vans, and sport utility vehicles, although it may also be used in a vehicle lift gate, as well.

The assembly may be installed in the opening of a vehicle body by use, on rigid frame 36, of any suitable adhesive, or by any suitable mechanical fastener, or by a combination of adhesives and mechanical fasteners. Preferably, the assembly is adhesively bonded to the vehicle body by a single-component urethane adhesive.

Among the benefits of the present invention is that the molded-on flexible frame 20 and seal 22 form a watertight seal in relation to the substrate 10 and since the substrate/flexible frame/seal components are directly, adhesively bonded to the preformed, rigid frame 36. The two sub-assemblies are inherently precisely positioned relative to one another, so that a tight interference match is achieved, thus ensuring a water-tight seal. The so-called “double-whisker” configuration of the molded-on seal 22 is particularly capable of providing the desired watertight seal in the configuration of the present invention, as described herein.

A further benefit of the present invention is that the molded-on seal 22 eliminates the secondary assembly operation of attaching a separate seal to the window of the vehicle body.

The molded-on frame and seal structure of the subject invention are typically made by a process as generally described below. The mold consists of an upper or core portion and a lower or cavity portion.

After placement of a substrate into the upper or lower mold portion the mold portions are brought into intimate contact, lock pins being inserted into lock pin recesses to ensure proper alignment of the mold portions. A mold cavity is formed within the secured mold halves, into which is injected a suitable polymeric material to form the flexible molded on frame and flexible seal structure.

After sufficient curing of the polymeric material, the upper and lower mold portions are moved apart, now having a flexible frame 20 and flexible seal structure 22 adhered to substrate 10 as shown in FIGS. 1 and 3.

The foregoing discussion discloses and describes exemplary embodiments of the present invention. One skilled in the art will readily recognize from such discussion and from the accompanying drawings and claims, that various changes, modifications and variations may be made therein without departing from the spirit and scope of the invention as defined in the following claims.

We claim:

1. A movable modular vehicle window assembly, comprising:
a sheet of a substrate material having major inner and outer surfaces and a peripheral edge therebetween; and
a flexible seal secured to the inner surface of the sheet, wherein the seal, for at least a portion of its length is adhered to the inner surface of the substrate material at a position that is spaced apart from the peripheral edge of the sheet.

2. The modular assembly of claim 1 wherein the flexible seal comprises a base portion from which at least two arm-like projections extend.

3. The modular assembly of claim 3, wherein the arm-like projections of the seal are at an angle greater than 90°, but less than 120°, relative to each other.

4. The modular assembly of claim 1, wherein the seal has been molded onto the inner surface of the substrate material.

5. The modular assembly of claim 1, wherein the seal is adhered to the inner surface of the substrate material with the aid of an adhesion-promoting primer.

6. The modular assembly of claim 3 wherein the seal comprises a thermoplastic elastomer material.

7. The modular assembly of claim 6 wherein the seal comprises a polyurethane material.

8. The modular assembly of claim 5 wherein the adhesion-promoting primer is a silane material.

9. The modular assembly of claim 2 wherein the base of the seal and the arm-like projections of the seal comprise different materials.

10. The modular assembly of claim 3 wherein the arm-like projections are adapted to be brought into pressing contact with a rigid surface such that the angle between the arm-like projections is increased, forming a releasable sealing bond between the arm-like projections and the rigid surface.
